(19) United States
(12) Patent Application Publication
(10) Pub. No.: US 2021/0274724 A1
(43) Pub. Date: Sep. 9, 2021

(54) FACILITY FOR CULTIVATING PLANTS IN A CONFINED ATMOSPHERE

(71) Applicant: AGRICOOL, Rouen (FR)

(72) Inventors: Gonzague GRU, ESTREES MONS (FR); Guillaume FOURDINIER, ROUEN (FR); Guillaume ROSSI, LE PERREUX SUR MARNE (FR); Guillaume BEAUDOIN, ARRAS (FR)

(21) Appl. No.: 16/328,441

(22) PCT Filed: Aug. 22, 2017
(86) PCT No.: PCT/FR2017/052260

§ 371 Date: Feb. 26, 2019

(30) Foreign Application Priority Data
Aug. 26, 2016 (FR) 16 57986

(51) Int. Cl. A01G 9/24; A01G 7/04; A01G 9/02; A01K 47/00

(52) U.S. Cl. CPC A01G 9/249; A01G 7/045; A01K 47/00; A01G 9/022; A01G 9/247

(57) ABSTRACT

Disclosed is a facility for cultivating plants in a confined atmosphere, including: a container having a length, a width and an inner volume, at least one portion of the inner volume forming a cultivation compartment; a system for supporting vertical cultivation supports; vertical cultivation supports attached to the support system; a vertical lighting system including light sources for illuminating the plants and arranged facing the vertical cultivation supports; and a mobility system for either moving the lighting system or for simultaneously moving two vertical cultivation supports, or both.

### TECHNICAL FIELD

This invention relates to the technical field of plant cultivation, and in particular the cultivation of planes in a container in a confined atmosphere.

### STATE OF THE ART

Cultivating plants in a confined atmosphere makes it possible to control the atmospheric conditions of growth of these plants. Thus, it is possible to control, among others, the temperature, the humidity, and the lighting.

With a concern for recovering used materials, reconverting containers has been popular for several years now. Thus, some have adapted used containers for the cultivation of plants. For example, document GB 2426015 describes a container modified to be used as a greenhouse with simply one access door formed on one of the sides with a shorter width. All of the inner volume of the container is intended to receive plants to be cultivated. Another example, document U.S. Pat. No. 3,673,733 describes such a container having a cultivation compartment where the plants can be placed and cultivated and a closed compartment in a box for the housing of equipment for controlling the atmospheric conditions for the growth of the plants, in particular electrical. The closed compartment is not intended to be easily accessible.

Unfortunately the arrangement of the plants inside these containers is not optimal. Indeed, the plants are arranged flat on the ground or stacked in shelves making it difficult to maintain them.

Solutions exist to save space. For example, JP H0420219 describes a facility comprising low walls whose two main surfaces have orifices for installing plants. These low walls are arranged parallel to one another. Light sources are attached to the ceiling so as to hang above corridors, each one formed by two adjacent walls. According to the authors, this facility makes it possible to provide a constant quality of light to the plants. Unfortunately, during the growth of the plants, those located at a higher level cast a shadow on those located at a lower level. Furthermore, the width of the corridors required for the maintaining of the plants does not allow for an adaptation in a container of which the width is limited.

Presentation of the invention One objective of the present invention is to overcome at least one of the constraints mentioned hereinabove, in particular improving plant-maintaining conditions, use of the space available in a container and lighting conditions for all the plants.

To this aim, this invention provides [1] a facility for cultivating plants in a confined atmosphere, comprising:

a container having a length, a width and an inner space, at least one portion of the inner space forming a cultivation compartment;

a system for supporting vertical cultivation supports;

vertical cultivation supports attached to the support system;

a vertical lighting system comprising light sources for illuminating the plants and arranged facing the vertical cultivation supports; and

a mobility system for either moving the lighting system or for simultaneously moving two vertical cultivation supports, or both.

The facility according to this invention in particular allows for the modulation of the space between the cultivation wall and the lighting system making it possible to both clear the space in front of the cultivation wall for the maintaining thereof and to adapt the distance between the lighting system and the cultivation wall as the plants grow.

Other optional and non-limiting characteristics are presented hereinafter.

[2] The facility such as described in the point [1] hereinabove, can further comprise an irrigation system for the transport of water and/or nutrients to the plants.

[3] In the facility such as described in the point [1] or [2] hereinabove, each one of the vertical supports can be a longitudinal profile that has, an upper end, a lower end and orifices through which the plants are intended to grow, the upper end of each one of the profiles comprising at least one fastening portion for attaching to the support system.

[4] In the facility such as described in one of the points [1] to [3] hereinabove, the support system can comprise a cultivation panel comprising one or several longitudinal support members, each one formed by two uprights and by an upper crosspiece connecting the two uprights at their upper ends, the upper crosspiece being oriented collinearly to the length of the container and comprising a plurality of at least one fastening portion for the fastening of the vertical cultivation supports; the mobility system comprising two cross rails arranged collinearly to the width of the container and two carriages, each one attached to the support member and cooperating with a rail for the translatory movement of the support member collinearly to the width of the container.

[5] In the facility such as described in one of the points [1] to [4] hereinabove, the mobility system can further comprise a control for actuating the movement of the lighting system or the simultaneous movement of two vertical cultivation supports.

[6] In the facility such as described in the point [5] hereinabove, the control can be actuated by rotating about an axis collinear to the length of the container, and wherein the mobility system can further comprise a belt or a transmission chain transmitting the movement of the control to one of the carriages.

[7] In the facility such as described in the point [5] or [6] hereinabove, the control can be a crank, a wheel or a control panel.

[8] In the facility such as described in one of the points [4] to [7] hereinabove, the fastening portions can be adapted to limit the translatory movement of the vertical cultivation supports along the upper crosspiece.

[9] In the facility such as described in the point [8] hereinabove, the limiters can be chosen from: orifices made through the upper crosspiece, notches made at the upper surface of the upper crosspiece, undulations of the upper crosspiece, buckles, loops or hooks attached to one or two lateral surfaces of the upper crosspiece, or a combination of the latter.

[10] In the facility such as described in one of the points [4] to [8] hereinabove, the lighting system can comprise a light panel.

[11] In the facility such as described in the point [10] hereinabove, the light panel can comprise one or several sides, with each one comprising light sources and light source fasteners on one or two lateral faces thereof.

[12] In the facility such as described in the point [11] hereinabove, the light sources can be comprises of LEDs, preferably LED tubes, in which case the fasteners are arranged in pairs for receiving each one of the LED tubes at two separate points.

[13] In the facility such as described in one of the points [10] to [12] hereinabove, the mobility system can comprise two upper cross rails arranged collinearly to the width of the container and two carriages, each one attached to an upper corner of the light panel and cooperating with a rail for the translatory movement of the light panel collinearly to the width of the container.

[14] In the facility such as described in one of the points [4] to [13] hereinabove, the irrigation system can comprise a perforated hollow tube arranged under the upper crosspiece, with the arrangement of the perforations of the hollow tube being adapted to the position of the vertical cultivation supports, preferably, the hollow tube is extended at each one of the perforations by tubules in such a way that each one of the perforations opens into a first end of the tubules thus forming T branches. Alternatively or furthermore, the irrigation system can comprise misters whose distribution is adapted to the position of the vertical cultivation supports.

[15] The facility such as described in one of points [1] to [14] hereinabove, can further comprise a separation that separates the inner space of the container into two compartments: the cultivation compartment and a service compartment forming an airlock chamber between the cultivation compartment and an environment exterior to the container. Preferably, the separation is hermetic.

[16] In the facility such as described in the point [15] hereinabove, the separation can comprise at least two separation panels, one of which is slidable with respect to the other.

[17] In the facility such as described in the point [16] hereinabove, at least one of the two separation panels can be transparent.

[18] The facility such as described in one of the points [15] to [17] hereinabove, can further comprise an irrigation system straddling the cultivation compartment and the service compartment.

[19] In the facility such as described in the point [18] hereinabove, wherein the irrigation system can comprise a reservoir of nutritive solution and a distributor of nutritive solution connected to the reservoir of nutritive solution, with the reservoir being arranged in the service compartment and the distributor in the cultivation compartment at the support.

[20] In the facility such as described in the point [19] hereinabove, the irrigation system can further comprise a plurality of nutrient reservoirs connected to the reservoir of nutritive solution for the preparation of the nutritive solution.

[21] The facility such as described in one of the points [18] to [20] hereinabove, can further comprise a system for recovering the nutritive solution flowing outside of the vertical cultivation supports.

[22] The facility such as described in the point [21] hereinabove, can further comprise a return circuit of the nutritive solution back to the reservoir of nutritive solution.

[23] The facility such as described in one of the points [15] to [22] hereinabove, can further comprise a compressor in order to ensure an overpressure within the cultivation compartment in relation to the service compartment.

[24] The facility such as described in one of the points [1] to [23] hereinabove, can further comprise a pollinator box, in particular bumblebees.

### DRAWINGS

Other objectives, features and advantages shall appear when reading the following detailed description in reference to the drawings provided for the purposes of information and in a non-limiting way, among which:

FIG. 1 is an example of a global view of the internal components of the cultivation compartment of a facility for cultivating plants in a confined atmosphere according to the invention;

FIG. 2 is the same view as FIG. 1 without the lighting system;

FIG. 3 diagrammatically shows an example of a support member for the support system of the facility according to the invention;

FIG. 4 is an example of a carriage for the mobility system of the facility according to the invention;

FIG. 5 diagrammatically shows an example of a light side for the lighting system of the facility according to the invention; and

FIG. 6 is a detailed view of an embodiment of the facility according to the invention showing in particular an adjustment of the inclination of the vertical cultivation supports and a system for recovering the nutritive solution flowing outside the vertical cultivation supports.

### DETAILED DESCRIPTION

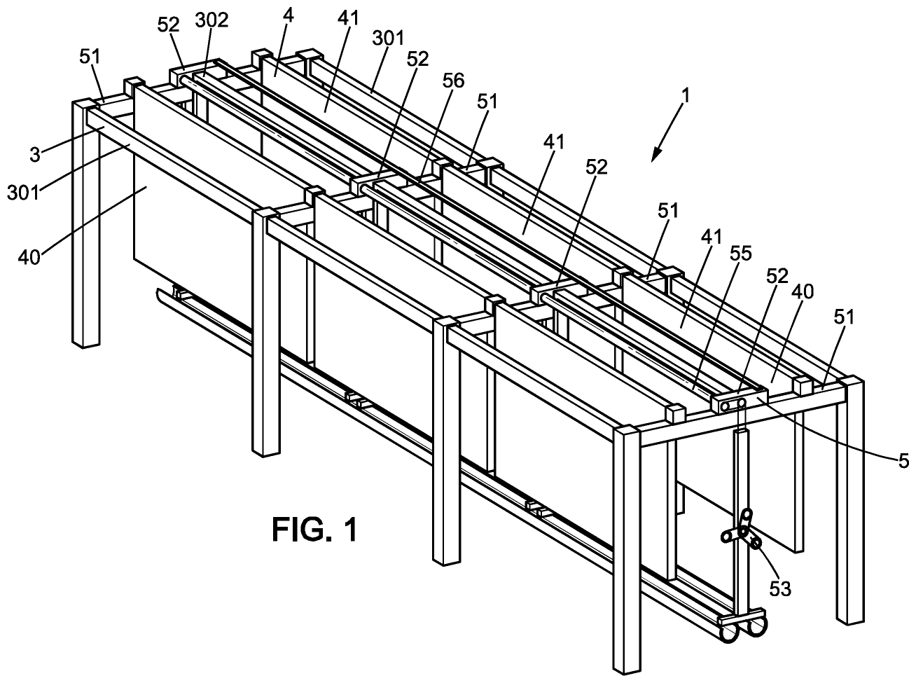

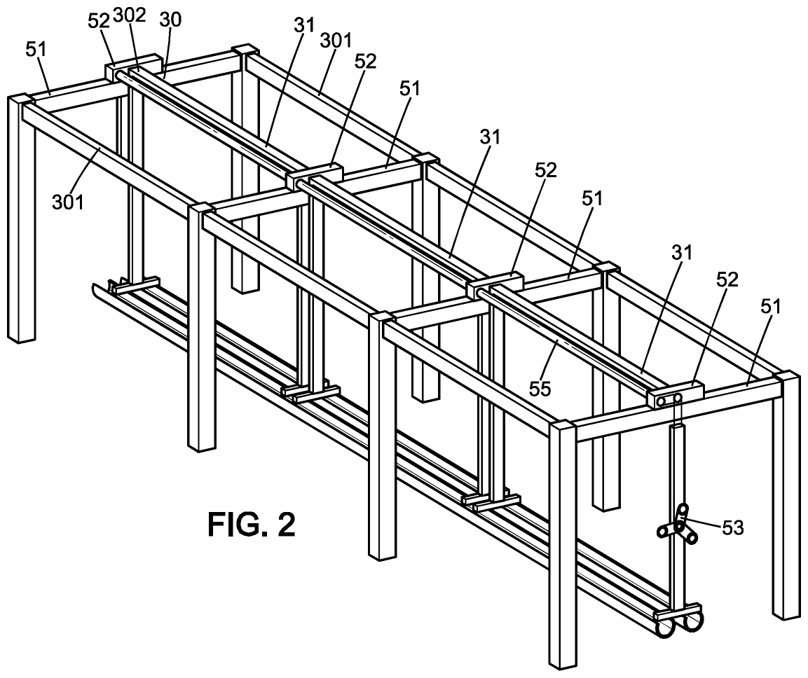

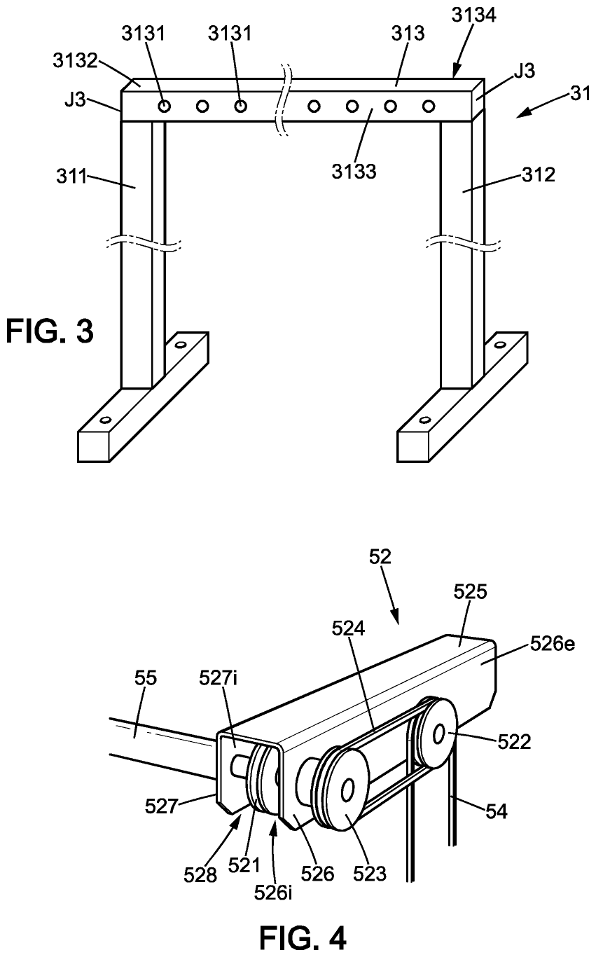

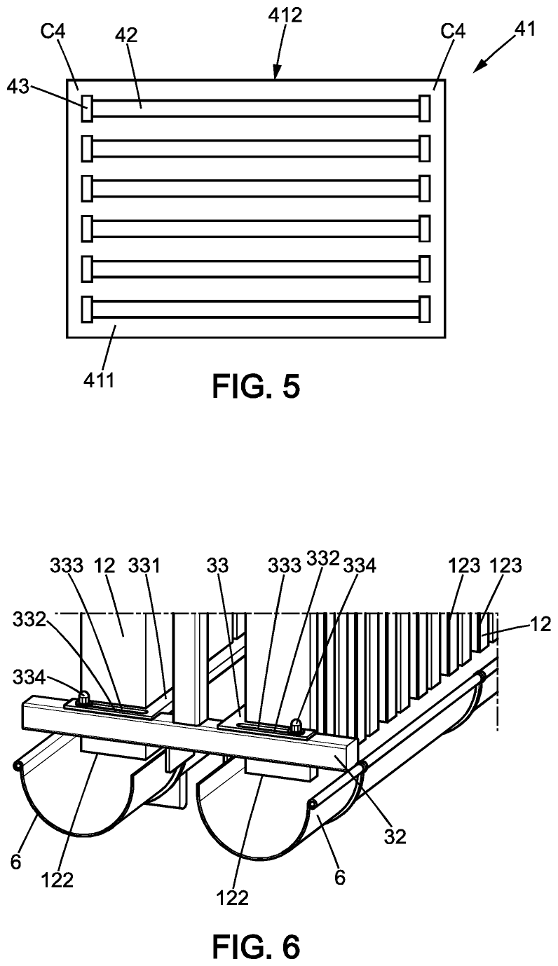

A facility for cultivating plants in a confined atmosphere according to the invention shall be described here in reference to FIGS. 1 to 6.

The facility 1 comprises in particular:

a container having a length, a width and an inner space, at least one portion of the inner space forming a cultivation compartment;

a system for supporting 3 vertical cultivation supports 12;

vertical cultivation supports 12 attached to the support system 3;

a vertical lighting system 4 comprising light sources for illuminating the plants and arranged facing the vertical cultivation supports; and

a mobility system 5 for the displacement either of the lighting system 4 or for simultaneously moving two vertical cultivation supports 12, or both.

Each one of the vertical cultivation supports 12 is preferably a longitudinal profile that has an upper end, a lower end 122 and orifices 123 through which the plants are intended to grow. The orifices 123 are preferably made on the same face of the vertical cultivation support 12. The upper end of each one of the profiles comprising at least one fastening portion for attaching to the support system. The fastening portion can be for example an orifice, a buckle, a loop or a hook. Each one of the vertical cultivation supports advantageously comprises a substrate, preferably non-earthen, inserted inside the longitudinal profile. For example, the substrate is made from a polymer foam adapted to the cultivation of plants.

The support system 3 can comprise a cultivation panel 30 comprising one or several longitudinal support members 31, each one formed by two uprights 311, 312 and by an upper crosspiece 313 connecting the two uprights 311, 312 at their upper ends. The upper crosspiece 313 is oriented collinearly to the length of the container and comprises a plurality of at least one fastening portion 3131 for fastening the vertical cultivation supports 12. The fastening portions 3131 preferably limit the translatory movement of the vertical cultivation supports 12 along the upper crosspiece 313 and can be for example orifices made through the upper crosspiece 313, notches made on the upper surface 3132 of the upper crosspiece 313, undulations (which can be described as an alternating succession of valleys and mountains) of the upper crosspiece 313, buckles, loops or hooks attached to one or two lateral surfaces 3133, 3134 of the upper crosspiece 313, or a combination of the latter. The fastening of the vertical cultivation supports 12 can be carried out directly between the latter and the upper crosspiece 313, for example by combining a hook on one side and an orifice, a notch, a valley, a buckle, a loop, a hook on the other side. The fastening can also be carried out indirectly through a third part, for example an S-shaped hook.

Preferably, the cultivation panel 30 comprises n longitudinal support members 31, n being an integer greater than 1, for example 2, 3, 4 and 5. The upper crosspieces 313 of the longitudinal support members 31 are aligned along their lengths, one following the other.

The cultivation panel 30 can be fixed or mobile, in this latter case, thanks to the mobility system 5.

The support system 3 can comprise several cultivation panels 30 which can be independently from one another, either fixed, or mobile. In this case, the cultivation panels 30 are aligned parallel to one another. Preferably, the support system 3 comprises two lateral fixed cultivation panels 301 and a central mobile cultivation panel 302. The lateral fixed cultivation panels 301 are intended to receive vertical cultivation supports 12 only on one of their lateral sides, in particular the one facing the other lateral fixed cultivation panel 301 and the central mobile cultivation panel 302 is intended to receive vertical cultivation supports 12 on both of its lateral sides.

Alternatively, the support system 3 comprises four cultivation panels 30 all mobile.

The support system 3 can further comprise an adjuster of the inclination of the vertical cultivation supports 12. For example, the adjuster comprises a bar 32, preferably hollow, and attached to the lower end of each one of the uprights 311, 312 of the support member and an adjustable longitudinal abutment 33. The bar 32 extends substantially perpendicularly to the upright but also orthogonally to the crosspiece 313. The adjustable longitudinal abutment 33 has a longitudinal portion 331 whose length is equal to that of the crosspiece 313, and two transverse portions 332 at each end of the longitudinal portion 331 and extending from the latter substantially perpendicularly and in the same direction. The adjustable longitudinal abutment 33 can also comprise spacers that make it possible to laterally shim the vertical cultivation supports 12. These spacers are for example transverse extensions extending from the longitudinal portion 331 and substantially perpendicularly to the latter and are spaced from one another by a distance substantially equal to the width of a cultivation support 12. An oblong orifice 333 is made through each one of the transverse portions 332 and parallel to their extension. The bars 32 each comprise a fastener 334 for fastening the longitudinal abutment. This fastener 334 comprises in particular a threaded rod. This threaded rod can be that of a bolt that cooperates with an orifice made in the bar or threaded rod protruding from the bar and cooperating with a nut. The threaded rod passes through one of the oblong holes 332 of the longitudinal abutment 33. The cooperation between the oblong hole 332 and the threaded rod allows for the adjustment of the vertical cultivation supports 12 in that the latter abut against the longitudinal portion 331 of the longitudinal abutment 33.

Preferably, each bar 32 extends on either side of the upright 311, 312 to which it is attached and has on each side a fastener 334 such as described hereinabove for the fastening of two longitudinal abutments 33. Thus, the vertical cultivation supports 12 on either side of the support member can be inclined.

Moreover, in the case where the fastening portion of the upper crosspiece 313 comprises an extension provided with limiters, for example a rod extending horizontally and perpendicularly with respect to the upper crosspiece and provided with notches or a system of bolts, the cooperation of the longitudinal abutment 33 with the extension allows for the horizontal displacement of the vertical cultivation supports 12 perpendicularly to the upper crosspiece 313.

Lighting system 1. The lighting system 4 typically comprises a light panel 40 arranged facing a cultivation panel 30 of the support system and parallel to the latter. Preferably, there is a light panel 40 for each one of the cultivation panels 30. Alternatively, there can be a light panel 40 for two cultivation panels 30 when the light panel 40 is arranged between the cultivation panels 30. The light panel 40 can comprise one or several sides 41, with each one comprising light sources 42 and fasteners 43 of light sources on one or two lateral faces 411, 412 of the latter according to the case where the light panel 40 is used to illuminate one or two cultivation panels 30.

In an embodiment of the lighting system 4, the light sources 42 are comprised of LEDs, for example LED tubes. In the case of LED tubes, the fasteners 43 are arranged in pairs for receiving each one of the LED tubes in two separate points, in other terms, each one of the LED tubes is maintained by two fasteners. Preferably, the fasteners are arranged so that the LED tubes extend horizontally and parallel to one another.

The lighting system 4 can comprise several light panels 40 that can be independent from one another, either fixed, or mobile. In this case, the light panels 30 are aligned parallel to one another. Preferably, the support system 3 comprises two mobile light panels 40, for example each one arranged between a fixed cultivation panel 301 and a mobile cultivation panel 302 of the support system 3.

Alternatively, the lighting system 4 comprises five light panels 40, of which two are fixed and which have light sources 42 only on one of their faces and two mobiles and having light sources on both faces, for example arranged with respect to four mobile cultivation panels 302, intended to carry vertical cultivation supports 12 on both of their lateral faces, in such a way that each mobile cultivation panel 302 is located between two light panels 40.

Hereinafter is described the mobility system 5 in the case where the latter is intended for the displacement of the support system 3. In this case, the mobility system 5 comprises two upper cross rails 51 arranged collinearly to the width of the container and two carriages 52 and parallel between them, each one fastened to the support member 311, 312, of the support system 3 at the junction J3 between the crosspiece 313 and one of the uprights 311, 312. The distance between the rails 51 is adapted to the distance that separates the carriages 52. Each one of the carriages 52 cooperates with a rail 51 for the translatory movement of the support member 31 collinearly to the width of the container. For this, each one of the carriages 52 in particular comprises a displacement wheel 521 that cooperates with the rail 51. The displacement wheel 521 can be toothed, in which case, the rail 51 is also toothed or notched.

Alternatively, the rails can also be lower cross rails, in which case, the carriages are attached to the support member 311, 312 at the lower portion thereof, for example on the lower ends of the uprights 311, 312.

The rails 51 can be smooth grooves (smooth wheel carriages 52) or racks (gear wheel carriages 52).

In the case where a mobile cultivation panel comprises n support members 31, the mobility system 5 advantageously comprises n+1 carriages 52 and n+1 rails 51. For this, the carriages 52 that are not located at the ends of the cultivation panels 30 are fastened to two support members 31. Thus, the crosspieces 313 of the support members are attached to one another by a carriage 52 at the junction J3 between a crosspiece 313 and an upright 311, 312. In other terms, if the support members 31 are numbered from 1 to n and the carriages 52 from 1 to n+1, each one of the carriages i other than the carriage 1 and the carriage n+1, is fastened to the support member i and i+1. The fastening of the carriages 52 to the support members 31 is done at the junction of an upright 311, 312 and of the crosspiece 313 of the corresponding support member 31. Thus logically, if the numbering of each one of the junctions (1 and 2) follows that of the support members and of the carriages, the carriage i is attached to the junction 2 of the support member i and to the junction 1 of the support member i+1. In this case, each carriage 52 cooperates with a rail 51 and can in particular comprise a displacement wheel 521 that cooperates with the rail 51. The displacement wheel 521 can be toothed, in which case, the rail 51 is also toothed or notched.

The displacement of the mobile cultivation panel 302 can be carried out manually, for example by pulling on the cultivation panel 302 in a transverse direction.

The displacement of the mobile cultivation panel 302 can also be carried out more easily using a control 53 to actuate the simultaneous displacement of two vertical cultivation supports, and in particular the translatory movement of the cultivation panel 30 along the rails 51. The simultaneous displacement of two vertical cultivation supports is either manual, or automated. In this case, the control 53 is preferably actuatable by rotating about an axis collinear to the length of the container and is preferably a crank, a wheel or a control panel. The mobility system 5 can further comprise a transmission belt 54 that transmits the movement of the control 53 to one of the carriages 52, preferably one of the end carriages, i.e. either the carriage 1, or the carriage n+1 when the number of support members 31 is n. Alternatively, the transmission belt 54 is replaced with a closed transmission chain.

Each one of the carriages 52 can then further comprise a control wheel 522, optionally toothed, linked in rotation to the displacement wheel 521 by a common rotation shaft. The control wheel 522 of one of the carriages 52 cooperates with the transmission belt 54 or the chain, in such a way that a movement of the control 53 about its axis of rotation drives the belt 54 or the chain in movement which in turn drives the control wheel 522 which drives the displacement wheel.

Preferably, the mobility system further comprises a transmission shaft 55. In the simplest case, the transmission shaft 55 is aligned on the axis of rotation of the control wheel 522 and of the displacement wheel 521. In another embodiment, with all other things remaining equal and wherein each carriage 52 further comprises a transmission wheel 523, optionally toothed, linked in rotation to the control wheel 522 by a belt 524 or a chain, the axis longitudinal of the transmission shaft 55 is the axis of rotation of the transmission wheels 523 of the carriages. In another alternative, the displacement wheel 521 and the transmission wheel 523 have the same rotation axis aligned to that of the transmission shaft 55, thus, in this alternative, the displacement wheel 521 does not have the same axis of rotation as the control wheel 522. In all of these cases, a movement of the control wheel 53 drives in rotation all of the control wheel 522, displacement wheel 521 and where applicable transmission wheel 523 of the carriages 52. The mobility system 5 can further comprise a longitudinal reinforcement 56 fastened to each one of the carriages 52.

Each one of the carriages 52 mentioned hereinabove can, independently from one another, comprise a base 525 and two wings 526, 527 extending substantially perpendicularly from the base 525 in the same direction and forming an inner space 528. If the carriage 52 comprises a control wheel 522, the latter is preferably rotatably mounted on the outer face 526e of one of the wings 526. If the carriage 52 comprises a displacement wheel 521, the latter is preferably rotatably mounted on the inner faces 526i, 527i of the two wings 526, 527. If the carriage 52 comprises a transmission wheel 523, the latter is preferably rotatably mounted on the outer face 526e of one of the wings 526, preferably on the same face as the control wheel 522. Each one of the carriages 52 can furthermore, independently of one another, comprise a second displacement wheel 521 of which the axis of rotation is the same as the one of the transmission wheel, if the first displacement wheel 521 has the same axis of rotation as the control wheel 522, or of the control wheel 522, if the first displacement wheel 521 has the same rotation axis as the transmission wheel 523. Where applicable, the longitudinal reinforcement 556 is attached to the base 525 of the carriages 52.

In the case where the mobility system 5 is intended for moving the lighting system 4, the description hereinabove will be adapted, in particular by fastening the carriages to the upper corners C4 of the sides 41.

In the case where the mobility system 5 is intended for moving the support system 3 and the lighting system 4, it can be with a control for one only or for both, for example, it has a control for the support system 3 and no control for the lighting system 4 such as described hereinabove. The parallel alignment of the rails 51 and the carriages 52 guarantee the parallel alignment of the cultivation panels 30 of the light panels 40 thus allowing for a uniform lighting over all of each one of the cultivation panels 30.

The mobility system 5 was described hereinabove for a so-called suspended system due to the rails arranged in the top portion. Alternatively, the rails of the mobility system 5 can be arranged in the lower portion. In this case, the carriages are attached in the lower portion of the support member(s) and/or of the light side(s). For example, the support member comprises a lower longitudinal crosspiece and the carriage is fastened to the junction between the lower longitudinal crosspiece and one of the uprights. Another example, the carriage is fastened to a lower corner of the light side. The carriages can be replaced with simple wheels.

A possible embodiment is to provide a mobility system in the lower portion for the support system and a suspended mobility system for the lighting system and vice versa.

The irrigation system can comprise a perforated hollow tube arranged on the upper crosspiece of the support member(s) of the support system and preferably collinearly to the latter. The arrangement of the perforations of the hollow tube is adapted to the position of the vertical cultivation supports, wherein the hollow tube can be interdependent or non-interdependent with the support member of the support system. The hollow tube can be extended at each one of the perforations by tubules in such a way that each one of the perforations opens into a first end of the tubules thus forming T-shaped diversion.

The facility can further comprise a misting system in order to humidify the atmosphere of the cultivation compartment. The misting system preferably comprises a duct through which water or steam is circulated. The duct comprises orifices at regular intervals through which the water is sprayed, for example through misters, or through which the steam is injected into the cultivation compartment.

The misting system can also be a part of the irrigation system when it is used for overhead irrigation of the plants.

A container (also designated as intermodal container) designates a parallelepiped metal caisson initially designed for transporting merchandise by various modes of transport such as road, rail and sea transport.

The container is preferably a container that has standard dimensions, in particular those given by the standard ISO 668 which defines the outside dimensions of containers, the width, the length, the maximum (empty) weight in order to make the containers as modular as possible by offering the maximum volume. Moreover, the containers defined by these standards can be transported indifferently by road, by train or by boat, for this, they can be incorporated into international road and rail sizes.

The exterior dimensions of the containers of the standard ISO 668 are summarised in the following table.

| Containers of the standard ISO | | Height (SI/Imperial) | | |
|---|---|---|---|---|
| 688 Constant width: 2.438 m/8′0″ | | 2.438/8′0″ | 2.591/8′6″ | 2.896/9′6″ |
| Length | 13.716/45′0″ | n.s. | 1EE | 1EEE |
| (SI/Imperial) | 12.192/40′0″ | 1A | 1AA | 1AAA |
| | 9.125/29′11.25″ | 1B | 1BB | 1BBB |
| | 6.058/19′10.5″ | 1CC | 1CC | n.s. |
| | 2.991/9′9.75″ | 1D | n.s. | n.s. |
| | 1.968/6′5.5″ | 1E | n.s. | n.s. |
| | 1.460/4′9.5″ | 1F | n.s. | n.s. |

n.s.: non-standard

The use of such containers facilitates the transport of the facility since the road, rail and sea circuits adapted to the transport of these containers already exist. Moreover, merchandise transport companies renew their containers on a regular basis making “last trip” containers available (generally after about fifteen years of use). Moreover, in some countries where the exported volume is less than the imported volume, there is a surplus of containers. The use of such containers therefore makes it possible to monetize an object that otherwise would not be reused again.

A balance between the inner volume of the containers and their availability in the second-hand market allows for manufacturing at lower cost. That is why the 40-foot High Cube containers (i.e. 1AAA) are preferred. Indeed, the 40-foot containers represent nearly 50% of all of the containers in the world.

However, this invention is not limited to the containers standardised by the standard mentioned. Containers that have other outside dimensions can also be used with optionally a dedicated transport circuit.

Generally, the containers are preferably refrigerated containers (also called reefer, refrigerated or CTR). The advantage of these containers is their tightness which makes it possible to obtain a controlled atmosphere while still requiring only very little additional sealing work or even none at all. Other types of containers that provide the same advantage are the simple isothermal containers, heated containers and containers in a controlled atmosphere which are also adapted for the manufacture of the facility according to the invention. The equipment that in particular makes it possible to control the temperature inside containers or to control the atmosphere is generally removed in order to have more space.

The cultivation compartment is a room formed in the container where the plants are cultivated. This compartment can occupy all of the inner volume of the container.

However, this compartment preferably occupies only a portion of the inner space of the container. The other portion is occupied by a service compartment. For this, the facility further comprises a separation, preferably hermetic, that separates the inner space of the container into these two compartments. The service compartment forms an airlock chamber between the cultivation compartment and the environment exterior to the container. The separation preferably comprises at least two separation panels of which one is slidable with respect to the other forming an access door to the cultivation compartment. At least one of the two separation panels can be transparent.

Entrance into the container is done preferably through the service compartment. For this, the service compartment can comprise a door that gives access to the outside of the container.

The facility can further comprise an irrigation system for the transport of a nutritive solution to the plants. This irrigation system is preferably straddling the cultivation compartment and the service compartment.

In this latter case, the irrigation system can comprise a reservoir of nutritive solution, a distribution circuit and a distributor of nutritive solution connected to the reservoir of nutritive solution by the distribution circuit. The reservoir is arranged in the service compartment, the distributor in the cultivation compartment at vertical cultivation supports. A tap is advantageously provided in the distribution circuit in the service compartment. This tap can be manually or automatically actuated. In this latter case, the irrigation system can further comprise a distribution control panel connected to the tap in order to open or close the latter or to adjust the degree of the opening thereof. The reservoir can be filled by hand with the nutritive solution prepared beforehand.

However, preparing the nutritive solution can also be carried out inside the service compartment. For this, the irrigation system further comprises a plurality of nutrient reservoirs connected to the reservoir of nutritive solution for the preparation of the nutritive solution and optionally a water inlet also connected to the reservoir of nutritive solution. Each one of these reservoirs of nutrients is intended to contain a solution rich in one nutrient favourable for the growth and the flourishing of the plants. It can comprise a valve that can be actuated by hand or with automatic actuation. In this latter case, the irrigation system can further comprise a control panel for preparing the nutritive solution connected to each one of the valves of the nutrient reservoirs. The water inlet can also comprise a tap that optionally controllable by the control panel. The preparation control panel controls the opening of the valves in order to obtain a nutritive solution of the desired composition.

The preparation control panel and the distribution control panel can be one and the same control panel when both are provided in the facility.

The facility can further comprise a system for recovering 6 the nutritive solution that flows outside of the vertical cultivation supports 12. For example, this recovery system 6 can comprise a gutter arranged under at least one portion of the vertical cultivation supports 12 in order to recover the nutritive solution that would flow therefrom. The gutter can comprise a hole at one of its ends. In this case, the gutter is preferably inclined in such a way that the end that has the hole is located lower than the other. The facility can comprise a recovery tray for the nutritive solution arranged under the hole, optionally provided with a spout. Alternatively, the recovery system 6 comprises a plurality of gutters aligned with one another along the longitudinal axis of the container, and of which the number is then preferably equal to the number of support members 31 in such a way as to provide a gutter under the vertical cultivation supports 12 attached to each one of the support members 31. The gutters are arranged in such a way as to have one end that is lower than the other. The arrangement of the gutters is provided in such a way that if two gutters are adjacent, their ends that are closest to one another are the low end for one and the high end for the other; these two ends are preferably connected fluidically to one another by the intermediary of holes made at these ends and by a pipe connecting the holes. Alternatively, the facility can further comprise a return circuit of the nutritive solution to the reservoir of nutritive solution.

The facility can further comprise a compressor to ensure an overpressure within the cultivation compartment in relation to the service compartment.

The facility can further comprise a pollinator box. Preferably, the pollinators are bumblebees.

In order to control the temperature inside the cultivation compartment, the facility can further comprise an air treatment unit. The air treatment unit is arranged inside the cultivation compartment, inside the service compartment or outside the container. When the air treatment unit is arranged outside the container, the latter is preferably arranged against the container in contact with a wall of the latter separating the exterior and the cultivation compartment.

In order to control the carbon dioxide content inside the cultivation compartment, the facility can comprise a source of carbon dioxide. The source of carbon dioxide can be arranged inside the cultivation compartment, inside the service compartment or outside the container.

Over the entire description hereinabove, the facility according to the invention has been described in reference to an embodiment wherein the cultivation panels and the light panels are aligned along the length of the container, i.e. the average plane of each one of the latter is parallel to the walls of the container located over its lengths. However, this invention is not limited to this embodiment. Indeed, it is possible to provide cultivation panels and light panels aligned according to the width of the container. Those skilled in the art will easily know how to adapt the various components of the facility described hereinabove to this embodiment according to the width, in particular the rails extending along the length of the container, the transmission axis extending along the width of the container. Only the separation between the service compartment and the cultivation compartment remains parallel to the width of the container. The door therefore opens onto a corridor serving the various cultivation panels and light panels.

1-19. (canceled)

20. Facility (1) for cultivating plants in a confined atmosphere, comprising:
a container having a length, a width and an inner space, at least one portion of the inner space forming a cultivation compartment;
a system (3) for supporting vertical cultivation supports (12);
vertical cultivation supports (12) attached to the support system (3);
a vertical lighting system (4) comprising light sources for illuminating the plants and arranged facing the vertical cultivation supports; and
a mobility system (5) for either moving the lighting system (4) or for simultaneously moving two vertical cultivation supports (12), or both.

21. Facility (1) according to claim 20, further comprising an irrigation system for the transport of water and/or nutrients to the plants.

22. Facility (1) according to claim 20, wherein each one of the vertical cultivation supports (12) is a longitudinal profile having an upper end, a lower end and orifices through which the plants are intended to grow,
the upper end of each one of the profiles comprising at least one fastening portion for attaching to the support system.

23. Facility (1) according to claim 20, wherein the support system (3) comprises a cultivation panel (30) comprising one or several longitudinal support members (31), each one formed by two uprights (311, 312) and by an upper crosspiece (313) connecting the two uprights (311, 312) at their upper ends, the upper crosspiece (313) being oriented collinearly to the length of the container and comprising a plurality of at least one fastening portion (3131) for the fastening of the vertical cultivation supports (12);
wherein the mobility system (5) comprises two cross rails (51) arranged collinearly to the width of the container and two carriages (52), each one attached to the support member (31) and cooperating with a rail (51) for the translatory movement of the support member (31) collinearly to the width of the container.

24. Facility (1) according to claim 20, wherein the mobility system (5) further comprises a control (53) for actuating the movement of the lighting system (4) or the simultaneous movement of two vertical cultivation supports (12).

25. Facility (1) according to claim 23, wherein the lighting system (4) comprises a light panel (40).

26. Facility (1) according to claim 25, wherein the light panel (40) comprises one or several sides (41), with each one comprising light sources (42) and fasteners (43) of light sources (42) on one or two lateral faces (411, 412) thereof.

27. Facility (1) according to claim 26, wherein the light sources (42) are comprised of LEDs, preferably LED tubes, in which case the fasteners (43) are arranged in pairs for receiving each one of the LED tubes at two separate points.

28. Facility (1) according to claim 25, wherein the mobility system (5) comprises two cross rails (51) arranged collinearly to the width of the container and two carriages (52), each one attached to the light panel (40) and cooperating with a rail (51) for the translatory movement of the light panel (40) collinearly to the width of the container.

29. Facility (1) according to claim 20, further comprising a separation that separates the inner space of the container into two compartments: the cultivation compartment and a service compartment forming an airlock chamber between the cultivation compartment and an environment exterior to the container; preferably, the separation is hermetic.

30. Facility (1) according to claim 29, wherein the separation comprises at least two separation panels of which one is slidable with respect to the other.

31. Facility (1) according to claim 30, wherein at least one of the two separation panels is transparent.

32. Facility (1) according to claim 29, comprising an irrigation system straddling the cultivation compartment and the service compartment.

33. Facility (1) according to claim 32, wherein the irrigation system comprises a reservoir of nutritive solution and a distributor of nutritive solution connected to the reservoir of nutritive solution, with the reservoir being arranged in the service compartment and the distributor in the cultivation compartment at the support.

34. Facility (1) according to claim 33, wherein the irrigation system further comprises a plurality of nutrient reservoirs connected to the reservoir of nutritive solution for the preparation of the nutritive solution.

35. Facility (1) according to claim 32, further comprising a system for recovering the nutritive solution flowing outside of the vertical cultivation supports (12).

36. Facility (1) according to claim 35, further comprising a return circuit of the nutritive solution back to the reservoir of nutritive solution.

37. Facility (1) according to claim 29, further comprising a compressor in order to ensure an overpressure within the cultivation compartment in relation to the service compartment.

38. Facility (1) according to claim 20 further comprising a pollinator box, in particular bumblebees.

39. Facility (1) according to claim 21, wherein each one of the vertical cultivation supports (12) is a longitudinal profile having an upper end, a lower end and orifices through which the plants are intended to grow,
the upper end of each one of the profiles comprising at least one fastening portion for attaching to the support system.
